(19) United States
(12) Patent Application Publication
(10) Pub. No.: US 2026/0208433 A1
(43) Pub. Date: Jul. 23, 2026

(54) DEVICE AND METHOD FOR ADDITIVELY MANUFACTURING PRODUCTS

(71) Applicant: MICRO FACTORY 3DSOLUTIONS GMBH, Landsberg am Lech (DE)

(72) Inventors: Maximilian STRASSER, Muenchen (DE); Leonard KREBS, Landsberg am Lech (DE); Alexander STIEREN, Muenchen (DE)

(21) Appl. No.: 19/126,749

(22) PCT Filed: Nov. 3, 2023
(86) PCT No.: PCT/DE2023/100815

§ 371 Date: May 2, 2025

(30) Foreign Application Priority Data
Nov. 4, 2022 (DE) 10 2022 129 168.5

(51) Int. Cl. B29C 64/124; B29C 64/25; B29C 64/35; B29C 64/379; B33Y 10/00; B33Y 30/00; B33Y 40/00

(52) U.S. Cl. CPC B29C 64/124; B29C 64/25; B29C 64/35; B29C 64/379; B33Y 10/00; B33Y 30/00; B33Y 40/00

(57) ABSTRACT

The invention relates to a device and a method for the stereolithographic production of products, whereby both the printing and the cleaning and subsequent post-curing of the product take place in a housing which can be sealed off from the environment.

The present invention relates to a device and a method for manufacturing products according to the principle of additive manufacturing. In particular, the invention relates to a stereolithography process in which a light source selectively cures a photopolymer (hereinafter also referred to as “resin”) in a container (resin container) by directing the light source specifically at individual areas in a container filled with resin. The light used for this, typically ultraviolet light, provides the radicals required for polymerization so that the resin hardens at the illuminated point. Typically, illumination is achieved by means of a printing unit through the underside of the resin container, which is designed to be locally translucent, for example with the aid of an appropriately controlled LCD matrix. The hardened product, which is created layer by layer in the liquid resin bath, adheres to a printing plate immersed upside down in the resin container, which is lifted slightly when one layer is completed so that the next layer can be created. This process is also known as “printing”. Once the printing process is complete, the product can be pulled upwards out of the resin container.

As a rule, a product created in this way must be cleaned of any adhering, uncured resin residues. For this purpose, it is known to immerse the finished printed product in a container with a cleaning medium in order to clean it of such unwanted components.

Such a device is known from CN 21 555 0999 U, in which both the actual printing and the cleaning take place within a common housing.

However, it is often necessary to subject the finished printed and cleaned product to post-curing in order to achieve the desired final strength of a fully cured photopolymer. For this purpose, the product can be exposed to a post-curing unit with a suitable light, whereby this final strength can usually be achieved within a few minutes. However, the effort required for post-curing is often considerable, as the product must first be removed from the printing device and placed in the post-curing unit, where it is then removed again after complete post-curing. It should also be noted that the photopolymer (resin) used in liquid form is generally classified as harmful to health and, in particular, contact with human skin, eyes, mucous membranes, etc. should be avoided wherever possible. The resin is only harmless in this respect once it has hardened. Handling a product that is not yet fully cured with liquid resin residue adhering to it is correspondingly difficult. There is also the problem that resin residues remain in the cleaning medium container during the cleaning process and reduce the effectiveness of the cleaning medium over time.

The task of the invention was therefore to create a device for producing products according to the principle of photopolymerization, which eliminates the aforementioned disadvantages.

The problem is solved by a device and a method as described herein. Further advantageous embodiments are also described herein.

The invention is based on the realization that a product based on the principle of photopolymerization of the aforementioned type can be created particularly easily and safely with the aid of a post-curing unit which is designed to irradiate the finished printed product automatically with suitable light for complete post-curing after it is pulled out of the resin container or the cleaning container. Unlike in the prior art, the post-curing unit thus be-comes an integral part of the device, which is therefore fully automatic for printing, cleaning and post-curing the product, without the product having to be removed before post-curing and fed to a separate post-curing process. This reliably prevents the operator from coming into contact with the photopolymer, which could be hazardous to health, and the post-curing step can be carried out immediately after the actual printing (product creation) or-if necessary after printing-a cleaning process, saving time and making it logistically simple without human intervention.

The device is designed to produce one or more products simultaneously in a repetitive process. This process comprises the actual printing process, in which one or more products can be produced adhering to a printing plate. If necessary, production also includes a subsequent cleaning process and, in any case, post-curing of the printed product(s) by means of the post-curing unit, after which a new production cycle can follow. A product manufactured in this way can, for example, be removed from or discharged from the device after post-curing has been completed.

The device according to the invention extends in three mutually orthogonal spatial directions, namely a preferably vertical direction Z, a longitudinal direction X and a transverse direction Y. The device comprises a production zone in which a product is produced layer by layer at a production position. The term “production zone” describes a spatial section within the device in which a resin container with resin contained therein is arranged during product creation (printing process) and in which the product is located during its generation.

Also provided is a holder that can be moved in a height direction Z to accommodate a printing plate. The printing plate is used to hold the product during its production. The holder can be moved up and down relative to the resin container in the height direction Z in order to hold a product produced in the resin container adhering to the printing plate and, in particular, to lift it layer by layer in order to enable the curing of a subsequent next layer below the layer produced immediately before.

Furthermore, a printing unit is provided to locally expose the resin held in the resin container locally with a light that causes the resin to cure locally in order to produce the product. Furthermore, the device according to the invention also comprises a cleaning container for holding a cleaning medium with which the product can be cleaned after it has been printed in the resin container. For this purpose, the printing plate with the product adhering to it can be automatically moved into the cleaning container in order to apply cleaning medium to the product there.

According to the invention, the device additionally comprises a post-curing unit compared to the prior art, in order to expose a product previously removed from the resin container or the cleaning container automatically to a light emitted by the post-curing unit (post-curing), which is suitable for post-curing the structures of the product that have not been cured or have not been completely cured. The post-curing unit is designed so that its light can be directed directly onto the product, which is still supported by the printing plate. Most preferably, the post-curing unit is designed so that the light it emits is directed into the production zone in order to post-cure the product positioned there. In accordance with the invention, post-curing can then take place within the production zone and does not require any additional space. The entire device can carry out the process steps “printing”, “cleaning” and “post-curing” fully automatically one after the other in a compact design. This solution overcomes a prevailing prejudice in the state of the art that post-curing cannot take place within the same device and in particular not within the production zone, since unintentional curing of the photopolymer in the resin container by the light of a post-curing unit must be avoided at all costs. The invention overrides these assumptions, although measures can be taken if necessary to avoid this unintentional hardening, as will be described below.

A further advantageous embodiment of the invention is directed to the cleaning medium in the cleaning container. As already mentioned, small amounts of uncured resin adhere to the printed product after each printing process. To wash these off, the finished printed product is preferably immersed in a cleaning container filled with cleaning medium. Isopropanol, for example, can be used as a cleaning medium, although other suitable cleaning media are also considered by specialists. However, the resulting resin residues in the cleaning medium reduce its quality and reusability in the long term.

The developers of the present invention have come to the realization that the resin residues accumulating in the cleaning container after curing can be particularly easily and effectively removed or filtered out of the usually liquid cleaning medium. One embodiment of the invention therefore provides for the cleaning medium in the cleaning container to be exposed to light, which hardens the resin residues accumulating in the container. It is particularly advantageous to use the light from the post-curing unit, which is also used for post-curing the product. As a result, one unit of the device performs a dual function in an inventive way, namely the post-curing of the product and the curing of resin residues in the cleaning medium.

In a particularly advantageous version of this development, it is provided that the cleaning container is arranged in the production zone and thus in the effective range of the post-curing unit, or at least can be moved there automatically. It is particularly practical to arrange the cleaning container permanently within the production zone. As part of the post-curing of the product by the post-curing unit described above, its light then also reaches the cleaning container in order to cure any resin residues that may be present in it—the post-curing unit or its light thus performs a dual function and is therefore utilized as effectively as possible. Although the irradiation of the product on the one hand and the cleaning container on the other hand can also take place one after the other or overlapping, the described advantages are particularly evident when the irradiation takes place simultaneously. Production times (if this also includes a cleaning process for the cleaning medium) can be reduced particularly well in this way, as separate treatment of the cleaning medium to harden the resin residues in it is then no longer necessary.

The operating materials used in photopolymerization as well as the cleaning medium used can be harmful to health. For this purpose, in one embodiment of the invention it is provided that the resin container is arranged together with the cleaning container and the post-curing unit in a tightly sealable housing in order to prevent harmful substances from escaping from the housing into the environment. The housing can be provided with suitable, preferably closable openings or connections, for example to remove a finished product from it (ejection flap) or to feed in operating materials such as resin or cleaning medium. Furthermore, ventilation openings can be provided to exchange air from the inside of the container-preferably cleaned by a corresponding filter unit—with the air surrounding the housing. For maintenance purposes, the housing can be opened to allow access to the individual components (in particular the resin container, the printing unit, the cleaning container and the post-curing unit) and to the production zone.

When post-curing the product in the device according to the invention, care must be taken to ensure that the light or scattered light emitted by the post-curing unit does not enter the resin container which contains the resin for printing the products. Otherwise, not only would the product specifically irradiated by the post-curing unit cure, but the resin in the resin container would also harden in places and it would no longer be possible to print a new product properly. Therefore, one embodiment of the invention provides a manually or automatically operable protective mechanism to protect the resin container against incident light with a curing effect when required.

In a simplest embodiment, the protective mechanism can be designed to cover the resin container in a light-tight manner, for example by automatically placing a lid on the top of the container. As soon as the lid closes the container, the post-curing unit can go into operation. To start another printing process, the cover must be removed again so that a fresh printing plate can be inserted into the resin tank.

Instead of using a lid, an advantageous alternative is to use the protective mechanism to move the resin container relative to the production zone into a protective zone, which is protected against the incidence of light from the post-curing unit. For example, the device can have an opaque partition wall with an opening, wherein the partition wall separates the production zone from the protection zone. The protective mechanism is then designed to move the resin container through this opening, either to one side or the other of the partition wall. For this purpose, the protective mechanism can comprise suitable (e.g. electromechanical) components, such as one or more drives, spindles, gears, levers, joints, etc. As the partition wall also serves to protect against the incidence of light, it could also be seen as part of the protective mechanism. The movement of the resin container between the production zone and the protection zone can be defined by suitable end positions. Sensors and the associated control unit can be used to evaluate when an end position is reached and take this into account in the control process.

If the resin container is in the production zone, a printing process can take place there. After printing (and, if necessary, cleaning by immersing the product in the cleaning container) and before post-curing begins, the protective mechanism can move the resin container through the opening into the protective zone. Preferably, one side of the resin container closes the opening in the partition wall (which can also be done in conjunction with the printing unit, see below). As the resin container is then positioned in the protection zone and protected from incident light from the post-curing unit, it can be put into operation in the production zone and emit its light onto the product (and preferably into the cleaning container at the same time).

The protective mechanism could, for example, have a linear drive equipped with a spindle and guide means to move the resin container linearly. Alternatively, it would be conceivable to move the resin container back and forth between the production zone and the protection zone by means of another movement that is appropriate to the spatial conditions of the device. This can include one or more swivel movements or translational movements or their superimposition (since the protection of the resin container is created by temporarily removing it from the effective range of the post-curing unit, the movement relative to the production zone theoretically also includes a movement of the production zone relative to the resin container, which remains stationary).

Although the protection of the resin container against the light of the post-curing unit is the main focus here, an advantageous embodiment of the invention provides for the resin container to be moved together with the printing unit between the production zone and the protection zone. There are several reasons for this, one of which is that the two components only function meaningfully in close proximity to each other and require each other for the printing process anyway.

A further reason lies in a further development of the invention in accordance with the invention by means of a further advantageous embodiment. It is initially assumed that the cleaning container has an upper opening through which the finished printed product can be lowered into the cleaning container in order to wash off excess resin residue. The cleaning media often contain volatile components that gradually escape from an un-sealed container. Apart from a loss of this operating fluid, it can also involve hazardous or flammable gases or vapors, the formation of which must be prevented as best as possible.

In an inventive interaction between the printing unit and the cleaning container, it is therefore provided in one embodiment of the invention to use the printing unit, when it is arranged in the production zone, to cover the opening of the cleaning container against the escape of cleaning medium. In particular, it is conceivable to arrange the printing unit (preferably together with the resin container arranged directly above it) in the production zone in preparation for a printing process in such a way that the printing unit simultaneously closes the cleaning container arranged below it with its underside. The printing unit forms a temporary lid on the cleaning container, which is open at the top. This arrangement makes use of the fact that the cleaning container is not used during the printing process anyway. Once the printing process is complete, when the finished printed product is to be immersed in the cleaning container, the resin container with the printing unit is no longer required in the production zone. With regard to the post-curing required after cleaning, it is more advisable to remove the printing unit (in particular together with the resin container) from the effective range of the post-curing unit in order to avoid the un-desired curing of resin in the resin container, as already described above.

One embodiment of the invention thus provides that the resin container can be moved from the production zone into the protection zone and back in order to either protect its contents from the post-curing unit or to make them available for product creation. In addition, the printing unit in the production zone can perform two tasks at the same time, namely the targeted application of light from below to the resin in the resin container to produce a product on the one hand and the covering of the cleaning container on the other. It is expedient to connect the resin container with the printing unit to form a jointly movable unit (resin container at the top, printing unit below in the vertical direction), so that the above-mentioned functions can be realized synergistically by moving the unit back and forth between the production zone and the protection zone.

A filling mechanism can be provided in the protection zone or in the production zone to fill the resin container with resin. For example, a storage container with a (preferably automatically) actuated valve can be arranged there to release fresh resin into the container. This can also be done while the product is being cleaned or post-cured, for example. The storage container can also be arranged outside a housing of the device, wherein at least one valve nozzle protrudes through a preferably sealed opening into the interior of the housing in order to be able to dispense resin into the resin container. In this case, the storage container is easier to replace.

An advantageous embodiment of the invention provides a carrier which is designed to hold a product during some of its production or processing steps and, if necessary, to move it within the device for this purpose. The carrier is designed to hold a holder, which in turn carries a printing plate with the product attached to it. Preferably, the carrier comprises a linear drive running in the height direction Z, with the help of which the holder and the product can be moved up and down. A production position can be defined in a first height range, within which the holder moves upwards during the actual printing process. Preferably, the cleaning container is located below the production position when viewed in height direction Z. Once the printing process is complete, the finished printed product is first lifted completely out of the resin container upwards in the height direction Z. The resin container can then be moved (preferably together with the printing unit) from the production zone in a transverse direction Y into the protection zone. As a result, the printing unit releases the opening of the cleaning container so that the product can be lowered in the height direction Z and immersed (in a second height range) into the cleaning medium of the cleaning container by subsequently lowering the holder.

Once the cleaning process is complete, the holder with the product can be moved upwards out of the cleaning container in height direction Z until it reaches a third height range in which the product can be exposed to the light of the post-curing unit. The first height range can be identical to the third height range to make the design as compact as possible. In this case, the post-curing unit directs its light into the production zone in which the product was previously printed. However, this does not rule out the possibility of light from the post-curing unit also reaching the cleaning container (preferably located underneath) in order to cure and filter out any resin residue in it deliberately.

As can easily be seen, this procedure enables printing as well as cleaning and subsequent post-curing in positions within the device that differ at most in terms of their height position in height direction Z. Movement of the product in the longitudinal direction X or in the transverse direction Y is not necessary between the individual processing steps with this process control and a correspondingly designed device; the X-Y coordinates can remain unchanged during this process. This allows a compact design of the entire device.

Preferably, the carrier can be pivoted about a pivot axis running in the height direction Z. This allows the holder to reach different swivel positions, at which different heights can also be reached due to the vertical movement of the holder. For example, the carrier can be swiveled into a discharge position in the area of a discharge flap. There, the printing plate can be automatically decoupled from the holder so that it can be released or removed from the device together with the product. Furthermore, preferably, the carrier can also be swiveled into a holding position of a magazine, where a new printing plate is coupled to the holder in order to print a new product on it. One conceivable solution would be a magnetic holder that can be activated automatically. The individual swivel positions (magazine, production zone, ejection flap) are preferably offset from each other by a swivel angle of 90°. Depending on the design of the carrier and/or the design of the device, other swivel angles can also separate the individual positions from one another.

An embodiment of the invention is also conceivable in which the finished product is automatically detached from the printing plate while still inside the device and released separately to the outside, while the printing plate can be used again immediately. In this case, there is no need to provide and connect new printing plates for each new product or for each new printing process. Instead, the same printing plate can be used for successive printing processes. A printing plate magazine within the device can then be omit-ted, which enables an even more compact design of the device. This also shortens the process time.

A particularly preferred embodiment of the invention comprises the following features individually or in single or multiple combinations:
a) the printing unit with the resin container arranged above it in the height direction Z can be positioned as a common unit in the production zone above the cleaning container in such a way that the printing unit seals one or more upper openings of the cleaning container there with an underside, while at the same time a product suspended from the holder can be produced in the resin container;
b) After the printing process has been completed, the unit consisting of the printing unit and the resin container can be moved out of the production zone into a protective zone protected from light, wherein the unit exposes the opening or openings of the cleaning container;
c) The holder with the product adhering to it can be lowered into the cleaning container in height direction Z after the printing process for cleaning purposes (cleaning);
d) the holder with the product adhering to it can be moved upwards out of the cleaning container in the height direction Z into the effective range of a post-curing unit after cleaning;
e) after cleaning the product, the post-curing unit is designed to irradiate both the product and a cleaning medium located in the cleaning container with light simultaneously in order to effect post-curing of the product and curing of resin residues present in the cleaning container.

Preferably, the device according to the invention comprises a control unit which is designed to control the individual components in order to control the production process fully automatically. The control unit can have a processor unit for this purpose, as well as elements for data storage and for (preferably bidirectional) data exchange with sensors, output units and other data processing devices. The control unit can be connected to or include an operator terminal via which a user can enter or read out programs or individual data, in particular process parameters. Furthermore, optical or acoustic display means can be provided and controlled by the control unit in order to signal the correct or faulty operation of the device. In particular, the exceeding of safety-relevant limit values could be signaled.

Since the resin has different properties depending on its temperature and can generally be processed better in a warmer state, for example, according to an advantageous embodiment of the invention it is provided to equip the resin container with heating or cooling means in order to be able to change the resin temperature automatically as required or maintain it at a certain predeterminable level.

A further advantageous embodiment of the invention provides a load cell which can be used to detect and check the weight of a printed product (preferably already during the process). The load cell is conveniently arranged between the holder and the printing plate and connected to a suitable control unit in order to record the current weight of the product during printing and compare it with reference values. In this way, the correct printing progress can be permanently checked for plausibility and the printing process can be terminated prematurely and/or restarted, for example, if specified weight tolerances are exceeded or not reached at a certain printing time.

In the following, one embodiment of the device according to the invention will be explained in more detail with reference to examples of figures. In the following

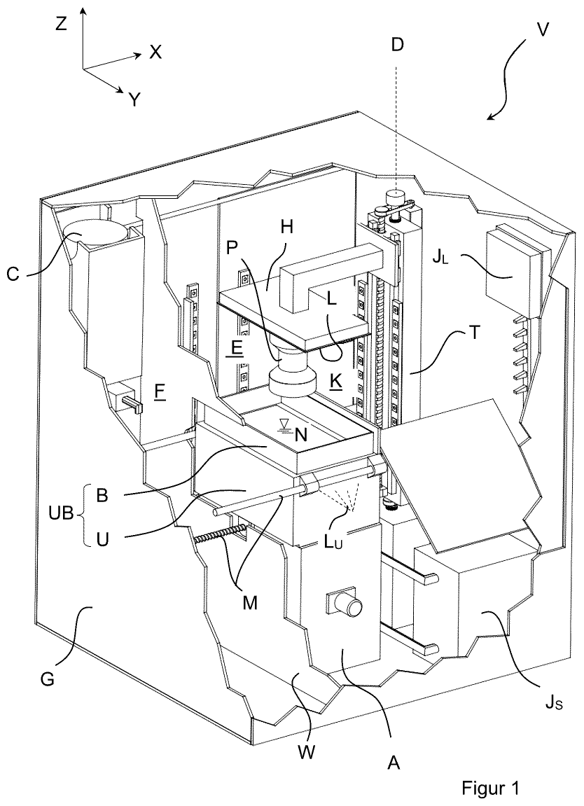

FIG. 1 shows a simplified perspective view of the interior of a device according to the invention immediately after the end of a printing process;

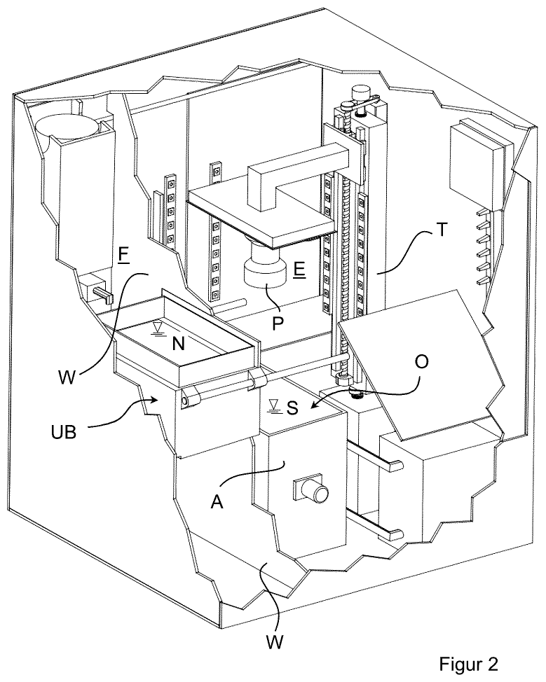

FIG. 2 shows the device shown in FIG. 1 in preparation for product cleaning;

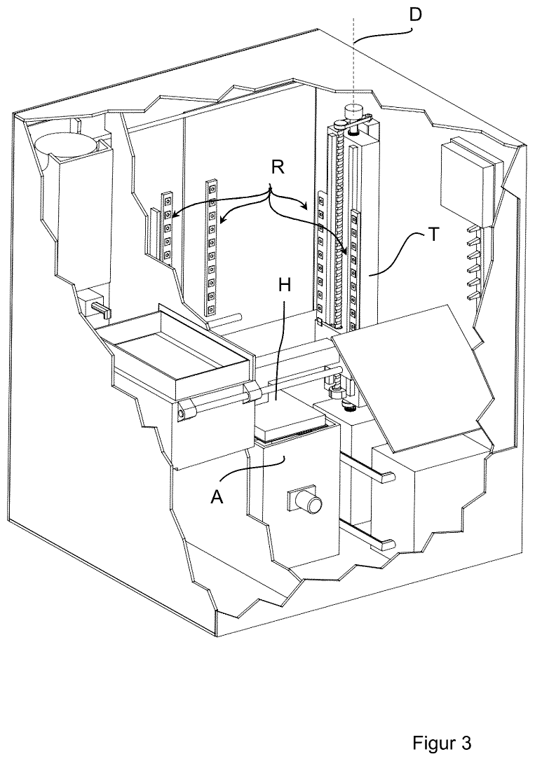

FIG. 3 shows the device shown in FIG. 1 during product cleaning;

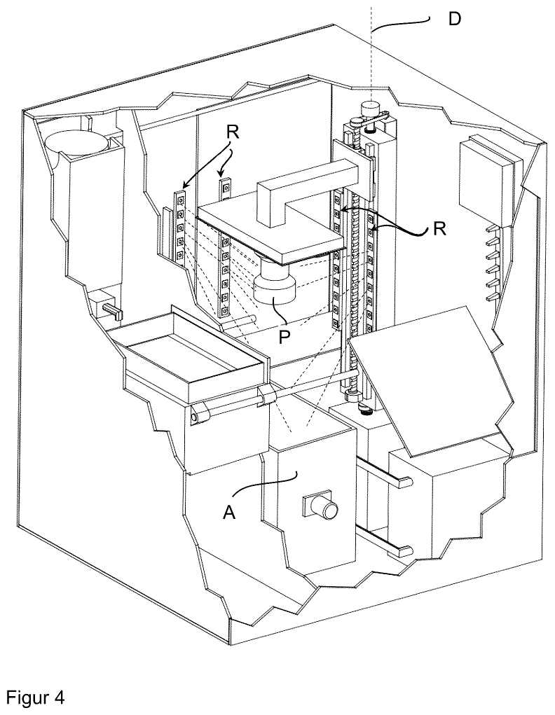

FIG. 4 shows the device shown in FIG. 1 during operation of the post-curing unit;

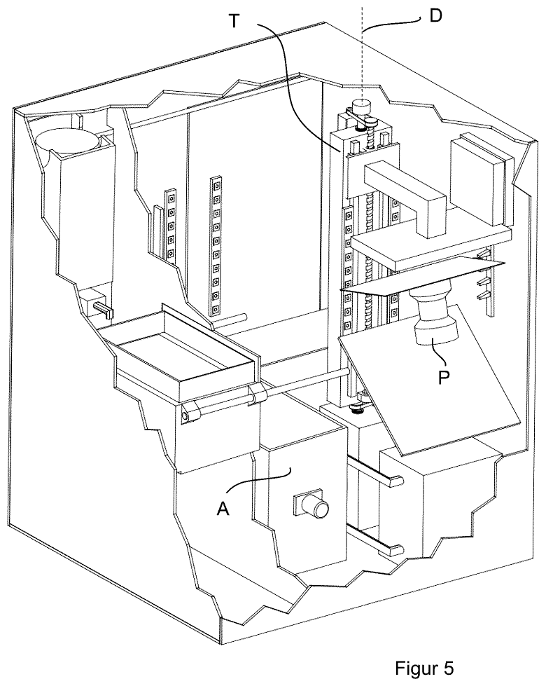

FIG. 5 shows the device according to FIG. 1 when delivering a finished product, and

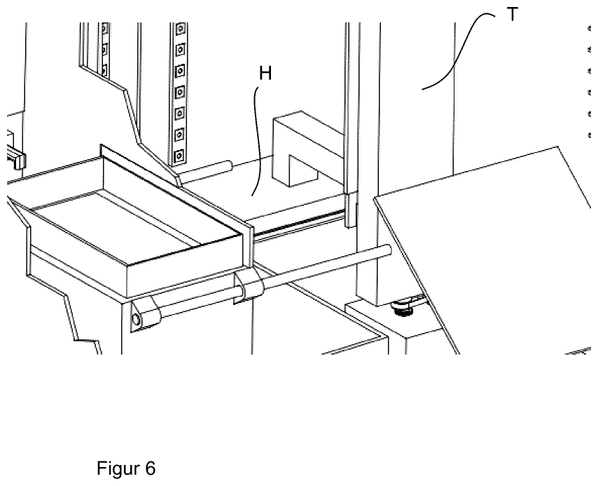

FIG. 6 shows a section of the device shown in FIG. 1 with the carrier swiveled. FIG. 1 shows a partially sectioned perspective view of a device V according to the invention. An essentially cuboid housing G extends in three mutually orthogonal directions (longitudinal direction X, transverse direction Y, vertical direction Z). A cleaning container A with an upper opening O is located approximately in the center of the lower area of the housing G (see FIG. 2, for example).

Above the cleaning container A in a production zone E is a printing unit U with a resin container B arranged directly above it. Together with the resin container B, the printing unit U forms a unit UB, which can be automatically moved back and forth in the longitudinal direction X between a protection zone F and the production zone E by means of a protection mechanism M. The protective mechanism comprises a motor-driven spindle interacting with the unit UB and guide rods, which are labeled “M” in FIG. 1 as a representative of possible further components of the protective mechanism. The production zone E is separated from the protection zone F by a partition wall W, wherein the partition wall has an opening so that the unit UB can be moved through this opening by means of a protective mechanism.

In FIG. 1, the unit UB is located in the production zone E at a production position K in order to produce a product P there. A carrier T is arranged in the longitudinal direction X laterally adjacent to the unit UB and the cleaning container A, which extends in the height direction Z and can be automatically pivoted about a pivot axis D running in the height direction Z. The carrier T comprises an unspecified linear drive, with the aid of which an arm projecting laterally from the carrier T with a holder H arranged thereon can be moved automatically up and down along the carrier T in the height direction Z. The holder H serves to hold a printing plate L. The printing plate L in turn serves to hold a product P, which is produced in the resin container B according to the principle of stereolithography.

For this purpose, the printing plate L can be lowered into the resin container B filled with a photopolymer (resin N) in the height direction Z by means of a holder H and carrier T. The printing unit U is designed to emit a light _{LU} that locally hardens the resin N in the resin container B into the resin container B in a targeted manner. The base of the resin container B is made translucent in a manner known to specialists, for example with the aid of a controllable LCD screen.

The resin cured by the light _{LU} of the printing unit in the resin container B adheres to the underside of the printing plate L or to a cured resin layer that has already been produced there. By curing locally in layers and lifting the printing plate slightly after each layer, a product P made up of several layers is created, which “hangs” on the underside of the printing plate L.

Meanwhile, the underside of the printing unit U covers the opening O of the cleaning container A, in particular to prevent volatile components of the cleaning medium S from escaping from the cleaning container A.

After completion of the printing process, the product P-hanging on the printing plate L—can be completely lifted out of the resin container B by moving the holder H upwards in the height direction Z by means of the carrier T. In this state, the product is largely finished, but there may still be residues of uncured resin adhering to it, and the product P is usually not yet fully cured at this point either.

The next step in the process is therefore to clean the product P of excess resin N. FIG. 2 shows that the unit UB, consisting of resin container B and printing unit U, has been moved in the longitudinal direction X from the production zone E into the protection zone F by means of the protection mechanism M in such a way that the resin container B in particular is protected in this position against the incidence of light from the production zone E or against the incidence of light from the post-curing unit. It can also be seen that the movement of the printing unit U has released the opening O of the cleaning container A, which is now open or accessible at the top so that the product P arranged on the holder H can be cleaned in it.

For this purpose, as shown in FIG. 3, the holder H is moved downwards from the production position K in height direction Z by means of carrier T until the product P is completely immersed in the cleaning container A or the cleaning medium S contained therein (lowered state). The cleaning process itself, in which excess resin N adhering to the product P is to be dissolved, can take a few seconds or even minutes. If an agitator is installed in the cleaning tank, it can cause a flow that supports cleaning. Conveniently, the holder H or the printing plate L is designed such that it covers the opening O of the cleaning container A in the lowered state in order to prevent volatile components of the cleaning medium S from escaping from the cleaning container A even during cleaning. Ideally, no unwanted resin residue should remain on the product after cleaning.

A product P cleaned in this way must usually be post-cured in order to ensure that the resin N and any structures that have not yet fully cured are fully cured throughout the product. As can be seen in FIG. 4, the holder H with printing plate L and the now cleaned product P adhering to it is moved upwards out of the cleaning container A in height direction Z until the product P reaches the effective range of a post-curing unit N. Ideally, the effective range is selected so that it lies approximately in the production position K in which the product P was previously printed. This enables a compact design of the entire device and simplifies the control for positioning the holder H by means of carrier T.

The post-curing unit is designed to emit light LR, which is suitable for curing resin N. In particular, it can be light of the type that is also emitted by the printing unit U, wherein a specialist will select a light that is suitable in terms of wavelength and intensity depending on the type of resin used. Since the product P has already reached its final desired shape in the finished printed state and targeted local illumination of individual product areas is no longer necessary for post-curing, it is now sufficient to illuminate the product P more or less diffusely with the post-curing unit.

FIG. 4 accordingly shows several LED strips of the same type running in the height direction Z, which together represent the post-curing unit R and are designed to emit curing light from several sides in the direction of the product P. However, the post-curing unit is also designed to emit its light through the opening O of the cleaning container into the cleaning medium S contained therein below the product P. Thus, by utilizing synergy effects, both the product P and the cleaning medium S are irradiated with curing light from the post-curing unit R, which is indicated by the dashed lines emanating from the post-curing unit in FIG. 4. As a result, not only does the product P undergo the desired post-curing, but (in the case shown) resin residues in the cleaning medium S are also exposed to curing light in order to cure these residues (and later filter them out of the cleaning medium). This effect is based on the realization that the same light from the post-curing unit can be used for both functions. Ideally, the cleaning container A is arranged as close as possible to the post-curing unit. The arrangement of the cleaning container A in the height direction Z below the production position K or the production zone E is particularly favorable, as shown in the figures. The movement of the product P between the process steps “printing”, “cleaning” and “post-curing” can then be limited to a purely vertical movement in the height direction Z, and the cleaning container A can be easily and directly reached by the light of the post-curing unit. The post-curing process step preferably only takes a few minutes.

Once the post-curing process has been completed using the post-curing unit, the product P is ready and can be removed from the container G. For this purpose, as shown in FIG. 5, the holder H can be moved into the area of an ejection flap by automatically pivoting the carrier T and, if necessary, moving it vertically in the height direction Z. There, the printing plate L can be automatically released from the holder by means of a mechanism, not shown in detail, so that the printing plate L, together with the product P adhering to it, falls onto an inclined steering plate, on which the product can be released to the outside from the inside of the housing G through an opening (preferably closable) not shown in detail.

To accommodate a new printing plate L, the holder H of the carrier T, as shown in FIG. 6, can be moved or pivoted about its axis D into a magazine area inside the housing G. There are further printing plates in one or more stacks, one of which can be automatically coupled to the holder H. The holder H with printing plate P can then be moved back to the production position K. Once the UB unit has also been moved from protection zone F to production zone E, a new product can be printed.

FIG. 1 also shows a resin storage container C, which is used to fill the resin container B (preferably automatically) when the resin container is located in the protection zone F. In addition, an air filter JL is provided to filter the air inside the container G before it leaves the container. The filter can be used to retain hazardous or flammable substances that are released from the resin N or the cleaning medium S inside the container, for example. A filter JS for the cleaning medium S is also provided in order to be able to filter out hardened resin components or other components from the cleaning medium. Preferably, the cleaning medium S is automatically circulated through the filter JS.

### REFERENCE SIGN

A Cleaning container
B Resin container
C Resin storage container
D Swivel axis
E Production zone
F Protection zone
G Housing
H Holder
K Production position
JL Air filter
JS Filter for cleaning medium S
L Printing plate
_{LU} Light of the printing unit
_{LR} Light of the post-curing unit R
M Protection mechanism
N Resin
O Opening of the cleaning container
P Product
R Post-curing unit
S Cleaning medium
T Carrier
U Printing unit
V Device
W Partition wall
UB Common unit consisting of resin tank B and printing unit U
X Longitudinal direction
Y Transverse direction
Z Height direction

1. A device for the additive manufacturing of products, comprising:
a production zone for a printing process in which a product is produced layer by layer at a production position by local curing of a flowable resin that hardens under light irradiation,
a resin container for holding the resin during the printing process,
a holder movable in a vertical direction for receiving a printing plate, wherein the vertical direction, a longitudinal direction and a transverse direction each extend orthogonally to one another, and wherein the holder is configured to be moved up and down relative to the resin container in the vertical direction in a targeted manner in order to hold a product produced in the resin container adhering to the printing plate,
a printing unit for locally exposing the resin held in the resin container to a light causing local curing of the resin to produce a product, and
a cleaning container for holding a cleaning medium, wherein the printing plate with a product adhering thereto can be is configured to be moved automatically into the cleaning container in order to apply cleaning medium to the product,
wherein a post-curing unit is provided in the device, which is configured to emit light that post-cures the resin in order to automatically apply the light of the post-curing unit to a product adhering to the printing plate and previously removed from the resin container,
wherein the device is configured automatically to keep an opening of the cleaning container closed during the printing process by the opening being sealed by the printing unit in order to prevent the cleaning medium or its vapors from escaping from the cleaning container.

2. The device according to claim 1, wherein the cleaning container is arranged in the production zone and thus in the effective range of the post-curing unit or is configured to be moved there automatically in order to cure resin components present in the cleaning container by means of the light emitted by the post-curing unit.

3. The device according to the claim 2, wherein the device is configured to carry out the post-curing of the product and the curing of resin components in the cleaning container successively, overlapping in time or simultaneously by means of the post-curing unit.

4. The device according to claim 1, wherein the resin container, the cleaning container and the post-curing unit are arranged in a common, tightly sealable housing in order to prevent harmful substances from escaping from the housing into the environment.

5. The device according to claim 1, wherein a manually or automatically operable protective mechanism is provided, which is configured to protect the resin container against exposure to light from the post-curing unit in order to prevent the curing of resin present in the resin container.

6. The device according to the claim 5, wherein the protective mechanism is configured to protect the resin container,
to cover light-tight, or
to move relative to the production zone into a protective zone, which is protected against the incidence of light from the post-curing unit.

7. The device according to claim 1, wherein the printing unit is configured to be moved together with the resin container from the production zone into a protection zone and back, wherein at least one of:
the resin container in the protection zone is protected against exposure to light from the post-curing unit, and
the printing unit positioned in the production zone is configured to cover an opening of the cleaning container to prevent the cleaning medium from escaping.

8. The device according to claim 1, comprising a support carrying the holder, wherein the support is configured to at least one of:
move the holder, the moving the holder comprising one or more of moving the holder automatically in space or in the vertical direction, during product creation or for cleaning purposes or for post-curing, and
swivel the holder, the swiveling the holder comprising one or more of swiveling the holder about a swivel axis or parallel to the height direction, between different swivel positions in order, depending on the swivel position,
to transfer a printing plate with product adhering to it into an ejection position in which at least one of the printing plate and the product is configured to be ejected from the device, or
pick up a new printing plate from a printing plate magazine in order to be able to produce a further product adhering to it, or
to create a new product.

9. The device according to claim 1, wherein at least one of:
the printing unit with the resin container arranged above it in the height direction is configured to be positioned as a common unit in the production zone above the cleaning container in such a way that the printing unit seals an upper opening of the cleaning container with an underside, while at the same time a product suspended from the holder is configured to be produced in the resin container,
that after the printing process has been completed, a unit formed jointly from the printing unit and the resin container configured to be moved out of the production zone into a protective zone protected from light, thereby releasing the opening of the cleaning container,
that the holder with the product adhering to it is configured to be lowered into the cleaning container in the vertical direction after the printing process for cleaning,
that the holder with the product adhering to it is configured to be moved upwards again out of the cleaning container in the vertical direction into the effective range of a post-curing unit after cleaning has been completed, and
that the post-curing unit is configured to simultaneously irradiate both the product and a cleaning medium located in the cleaning container with light after cleaning the product in order to effect post-curing of the product and curing of resin residues present in the cleaning container.

10. A method of manufacturing a product with the device according to claim 1, comprising:
producing a product held with the printing plate in a resin container by locally curing a resin by means of light emitted from a printing unit while the resin container is at a production position in a production zone,
subsequent protection of the resin in the resin container against possible irradiation with light from the post-curing unit, in that the resin container is automatically covered by a protective mechanism or moved into a protective zone separated from the production zone in such a way that light from the post-curing unit emitted in the production zone cannot penetrate into the protective zone.

11. The method according to claim 10, further comprising at least one of:
automatic cleaning of the product, comprising moving the printing plate with the product adhering thereto into a cleaning container, wherein the cleaning container comprises one or more of being arranged in the production zone or in the height direction below the production position,
automatic post-curing of the product by irradiation with light from the post-curing unit, and
automatic curing of resin accumulating in the cleaning container, wherein the automatic curing of resin accumulating in the cleaning container comprises one or more of automatic curing by irradiation with light of the post-curing unit, or the automatic curing occurs at the same time or overlapping in time with a post-curing of the product by means of the post-curing unit.
